(19) United States
(12) Patent Application Publication
(10) Pub. No.: US 2011/0249458 A1
(43) Pub. Date: Oct. 13, 2011

(54) Illuminated Panel Portion and Method of Production Thereof

(75) Inventors: Ron W. Kleber, Homer Glen, IL (US); George G. Kleber, Homer Glen, IL (US); Randy G. Kleber, Oak Forest, IL (US)

(73) Assignee: Gator Licensing LLC, Chicago, IL (US)

(21) Appl. No.: 12/759,204

(22) Filed: Apr. 13, 2010

(51) Int. Cl. B62J 6/00; B41M 5/42

(52) U.S. Cl. 362/473; 427/145

(57) ABSTRACT

The present disclosure generally relates to panel portions of an apparatus or assembly with a translucent or semitranslucent portion for the illuminated display of visible designs or ghosted designs. More specifically, a panel or a method of producing a panel having a translucent portion for illumination of a selected design. A translucent portion is made in a nontranslucent panel by layering a composite having translucent properties on a weakened portion of the nontranslucent panel, then removing the weakened portion from the back and layering a second layer of composite with translucent properties.

### FIELD OF THE DISCLOSURE

The present disclosure generally relates to panel portions of any apparatus or assembly including, without limitation, cabinets, walls, machines, vehicles and other vehicular accessories with a translucent or semitranslucent portion for the illuminated display of visible designs or ghosted or selectively visible designs. More specifically, present disclosure generally relates to a panel or a method of producing a panel having a translucent portion for the selective illumination of a selected design.

### BACKGROUND

Illuminated devices for vehicles and vehicular accessories have traditionally been used to enhance the visibility or customize the appearance of vehicles. Also, illuminated devices have served to illuminate selected designs such as indicia, emblems, pictures, outlines, or other such artistic and other designs.

Illuminated devices known in the art are designed to be mounted on various vehicle or vehicular accessory surfaces. For example, it is known that an illuminated automotive emblem for a motor vehicle may have a translucent display template that is illuminated from behind by a light source. In particular, illumination devices may be mounted on a gas tank or shell.

These and other prior illumination devices are typically mounted onto or protrude from the surfaces of the vehicle or vehicular accessory. Such a mounting arrangement can actually increase the possibility of damage to the underlying machinery or circuitry protected by the support surface. For example, water may seep under the illumination device and pool between the mounting surface of the illumination device and the surface of the vehicle or vehicular accessory. If the illumination device covers an aperture in the apparatus or assembly, such as vehicle or vehicular accessory surface, water can sometimes seep under the mounting surface of the illumination device and damage underlying machinery or circuitry.

Illumination devices are also typically mounted or protrude above the surface of the apparatus or assembly, such as, a vehicle or vehicular accessory. This mounting arrangement alters the preexisting contour of the surface. By altering the contour of the vehicle or vehicular accessory surface, the aerodynamics, appearance or aesthetics, and performance of the vehicle and/or vehicular accessory may also be compromised. These potential drawbacks may be a disincentive for consumers to mount or install such illumination devices on their vehicles and/or vehicular accessories.

In a variation of the above mounting techniques, another mounting arrangement is known wherein the desired design of the indicia is cut from the surface of the vehicle or vehicular accessory. This arrangement causes the edges of the cut-out portion to be raised above the outer surface of the illumination device. Moreover, because the indicia is cut out, the complexity of the indicia design is necessarily limited in order to maintain the structural integrity of the support surface of the vehicle or the vehicular accessory.

In yet another variation, an aperture is cut in the body panel of a vehicle or vehicular accessory at the location of the desired design. A panel is created having the same geometry and fitted into place. While one aspect of this prior variation is to provide an illuminated panel portion including a generally translucent panel with an outer surface, which avoids one or more of the drawbacks of prior illumination devices described above, the fitting of a panel having different materials of construction may result in thermal and mechanical issues at the interface between the vehicle and the panel. As the vehicle or vehicular accessory expands when heated under the sun or contracts due to cold weather, the aperture dimensions may change. As a consequence, bonding agents placed at the interface may be strained.

Apparatus or assemblies, such as, car fenders, cabinets, walls, machines, vehicle parts or vehicular accessories are generally made of a thin material, such as a metallic, plastic, composite or other like material, to reduce the weight or cost of the part and/or improve overall fuel consumption of the vehicle on which the part is attached. Currently, logos, advertising, and other design elements may be secured on the apparatus or assemblies, such as, cabinets, walls, machines, vehicle parts and vehicular accessories using an adhesive, a vinyl, or some fixation device or method. Currently, one disadvantage of painted elements or vinyl coated layers placed upon vehicle parts are difficult to see when the level of natural illumination drops. Phosphorescent or reflective paint can be used to enhance night display of these design elements, but these solutions are not optimal.

What is needed is a new technology for illuminated panels, a method of fabrication of same, and a new generation of translucent panels for displaying a selected design that overcomes the disadvantages of prior designs.

### SUMMARY

It is within the teachings of the present disclosure that the embodiments, concepts, ideas, teachings and methods herein are merely illustrative of but one application of this technology and shall not be limited to vehicles or vehicular accessories, which have been described in detail herein. Rather, it will be recognized that any other apparatus or assembly that may have a panel on which a design or illuminated design is desired shall be considered within the teachings of the present disclosure. Such apparatus or assembly may include, without limitation, vehicles, vehicular accessories, cabinets, walls, machines, or the like. Subsequent use of the terms vehicle or vehicular accessories shall be considered a reference to and shall include all other apparatus or assembly that may have a panel portion or any other alternative embodiment described or suggested herein, and shall be freely substituted therefor. Any reference to the body of a vehicle is likewise a reference to any body panel of an apparatus or assembly that may have a panel portion.

The present disclosure generally relates to panel portions of apparatus and assemblies, such as, cabinets, walls, machines, vehicles and other vehicular accessories with a translucent or semitranslucent portion for the illuminated display of visible designs or ghosted or selectively visible designs. More specifically, the present disclosure generally relates to a panel or a method of producing a panel having a translucent portion for illumination of a selected design. A translucent portion is made in a nontranslucent panel by applying a first composite layer having translucent properties on a weakened portion of the nontranslucent panel, then removing the weakened portion from the back and applying a second composite layer having translucent properties to define a translucent panel in the nontranslucent panel.

Once a panel is formed and sanded to even out asperities, a design element is created with a stencil and a coat of polymer to cover the nontranslucent panel. A coat of colored translucent polymer may be used to improve the effect of the design element. A lighting source can also be used to further enhance the aesthetic element of the design. A “ghosted” or selectively visible effect can also be added by covering the translucent or colored translucent design element with a coat of semitranslucent polymer to block normal light but allow for the color light to shine through the semitranslucent polymer. Methods for making this illumination panel and its variants are also disclosed.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 is a perspective view of a vehicle including a body panel.

FIG. 2 is a front perspective view of a vehicle body panel such as, for example, the body panel of the vehicle of FIG. 1 with a mask and different cut guides made in the panel according to one embodiment.

FIG. 3 is a close-up view of one of the corners of the structure shown in FIG. 2 to illustrate slits formed between corner cut guides to weaken the panel.

FIG. 4 is a reversed or back perspective view of the body panel of FIG. 2 where a second mask made of tape is placed over the cut guides as preparatory work for a filler step.

FIG. 5 is a cross-sectional view of the body panel along line 5-5 shown in FIG. 2 having cut guides and both masks placed on each side of the body panel according to one embodiment of the present disclosure.

FIG. 6 is cross-sectional view of a subsequent step to FIG. 5 where a filler is disposed in the cut guides.

FIG. 7 is a cross-sectional view of a subsequent step to FIG. 5 where a mold release compound is disposed on the first side of the body panel.

FIG. 8 is a cross-sectional view of a subsequent step to FIG. 5 where one of the masks is removed.

FIG. 9 is a cross-sectional view of a subsequent step of FIG. 5 where a layer of translucent cloth is disposed over the mold release compound.

FIG. 10 is a cross-sectional view of a subsequent step of FIG. 5 where the nontranslucent panel is removed.

FIG. 11 is a cross-sectional view of a subsequent step of FIG. 5 where a layer of translucent cloth is disposed on a side of the body panel opposite the first layer of translucent cloth as shown in FIG. 9.

FIG. 12 is a perspective view of a vehicle with a “ghosted” design element on the body panel for illumination as shown in FIG. 1.

FIG. 13 is a cross-sectional view of FIG. 11 without showing the mold release compound layer for the purpose of simplicity.

FIG. 14 is a cross-sectional view of a subsequent step of FIG. 13 covered on one side using a color layer and a stencil.

FIG. 15 is a cross-sectional view of a subsequent step of FIG. 13 where a layer of polymer is used over the stencil to create a design element.

FIG. 16 is a cross-sectional view of a subsequent step of FIG. 13 where the stencil is removed so that light may shine through the design element and/or illuminate the panel.

FIG. 17 is a cross-sectional view of a subsequent step of FIG. 13 where a subsequent layer of semitranslucent polymer is disposed the panel to create a “ghosted” effect.

FIG. 18 is a perspective view of a vehicle of FIG. 12 where the design element is illuminated.

FIG. 19 is a perspective view of another vehicle where a design element is illuminated.

FIG. 20 is a diagrammatic illustration of the steps of a method for making an illuminated panel as embodied in FIGS. 5-11 according to one embodiment of the present disclosure.

FIG. 21 is a diagrammatic illustration of the steps of a method for making a design element in the illuminated panel as shown in FIGS. 13-16 according to one embodiment of the present disclosure.

FIG. 22 is a diagrammatic illustration of the steps of a method for making a shadow as illustrated in FIG. 17 according to one embodiment of the present disclosure.

### DETAILED DESCRIPTION

The present disclosure is not limited to the particular details as described and depicted, and other modifications, embodiments and applications may be contemplated. Further changes may be made without departing from the true spirit of the scope of the disclosure. It is intended, therefore, that the subject matter of this disclosure should be interpreted as illustrative, not in a limiting sense.

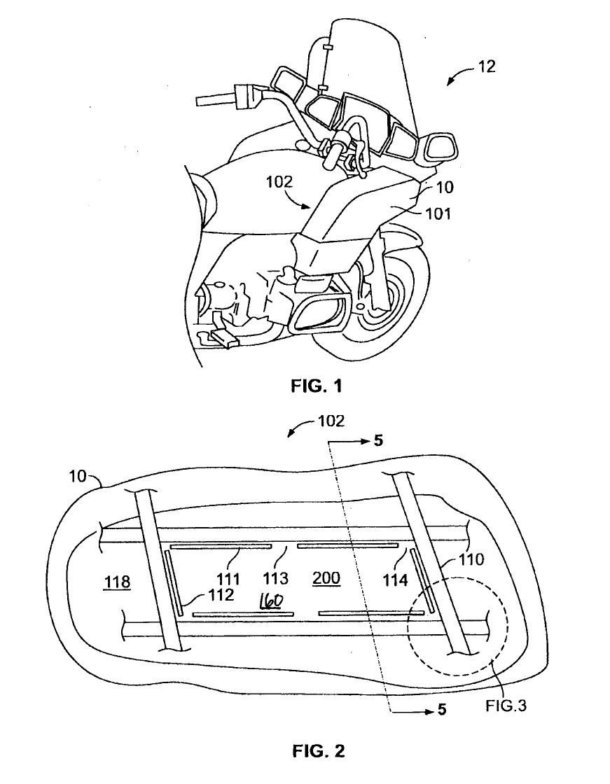

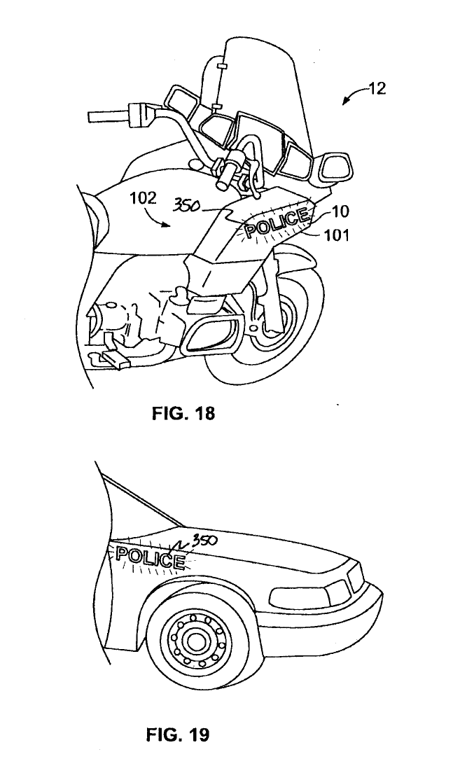

Design elements 350 as seen on FIGS. 18-19 are best noticed when they are illuminated. Street signs are easily perceived at night. They are lit either by the headlights of an oncoming vehicle, a series of colored and twisted neon, or by lights placed in the back of translucent or semitranslucent panels. For example, FIG. 1 shows an embodiment where a vehicle 12, for example a motorcycle, includes a body panel 10 with an inner surface 102 and an outer surface 101. The use of a backlight, colored or uncolored, placed within a body panel 10 to retro-illuminate a design element 350 as shown in FIGS. 18 and 19 is contemplated. While the below-described method, body panels, and illuminated body panels are described having one side as the inner surface 102 and the opposite side as the outer surface 101, what is known is the use of both sides interchangeably based on the different known applications.

In the field of customized vehicle parts or customized vehicular accessories, for either aesthetic reasons (e.g., placement of a decorative design to enhance the overall appearance of the vehicle) or functional reasons (e.g., the use of a sign such as a police emblem, and ambulance or fire truck designation, or a food delivery sign), a retro-illuminated design element 350 that can be seen from at a distance, in all weather conditions, and that is capable of withstanding normal operating condition of the vehicle part or customized vehicular accessories, is desirable.

Many parts and vehicular accessories are made of thin-walled material such as, for example, metal, plastic, composite and other like materials. Metal has a thermal dilatation coefficient and will change in overall dimension more than most other materials with smaller thermal dilatation coefficients. Consequently, when a metal panel is warmed under the sun, cooled in the wind or weather, or even placed in proximity to a warm component (e.g., such as a car hood's proximity to the engine), an aperture defined within the metal panel expands or contracts because of thermal expansion. For example, if a body panel is heated, the body panel expands and the size of an internal closed aperture shrinks, whereas if the body panel is cooled, the body panel contracts and the aperture grows larger. A translucent element fitted within such aperture will also expand if heated and shrink if cooled in accordance with its thermal dilation coefficient, which will be different as the materials are different. Accordingly, both pieces change dimensions concurrently at different rates as per different coefficients. A prior method describes using a beveled angle as an interface between the aperture in the panel and the translucent element. However, the panel and translucent element in such prior method have similar dilation coefficients. As a result, no significant strain or shear forces are introduced at the interface.

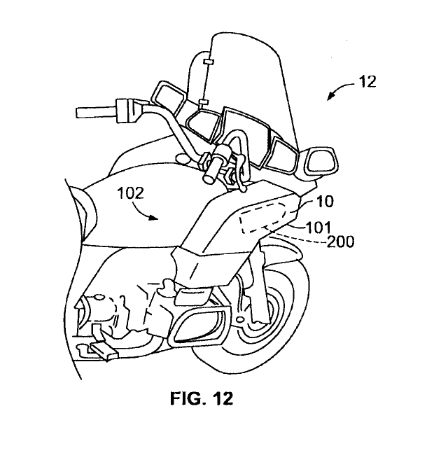

The present disclosure is also directed to body panels 10 and forming a translucent body panel portion 200, as shown in FIG. 12, that is disposed over an aperture 7 defined and shown in FIG. 10, and as shown before the aperture is made by slit cuts 111, 112 made in the surface 118 of a vehicle. This aperture 7 is made in a nontranslucent body panel portion 118, such as, for example, a panel of a car as shown in FIG. 19, a motorcycle as shown in FIG. 18, or any other vehicle surface or vehicular accessory. Those of ordinary skill in the art will recognize that the various embodiments of this disclosure may be applied equally to thin or thick-walled panels. One best mode is to use the disclosed method in connection with thin-walled panels, and more precisely, metal panels in order to generate the resulting apparatus.

FIG. 11 shows a translucent body panel portion 200 where two layers of translucent material 150, 161 are disposed successively on both sides of the external edge of the aperture 7 made in the nontranslucent body panel portion 118. In one embodiment, two successive layers of a composite that may include translucent cloth and thermoset resin or other like materials, are disposed over the aperture 7 to cover the opening and approximately one inch on either side of the edge of the opening in the nontranslucent body panel portion 118 or such other dimension sufficient to provide the desired connection. In a preferred embodiment, two layers 150, 161 are disposed on both sides of the aperture 7 on the inner surface 102 and the outer surface 101 of the nontranslucent body panel portion 118. An area of overlapping coverage (i.e., an area where the metal portion is covered by layers of translucent material) is shown in FIGS. 9-11, where the surface contact area 8 between the nontranslucent body panel portion 118 and the translucent body panel portion 200 reduces the linear shear and linear strain forces at the interface or aperture 7 to protect the translucent and nontranslucent body panels from cracks and fatigue resulting from thermal or mechanical cyclical loads. In addition, the nontranslucent body panel disposed in the surface contact area 8 is thermally insulated from temperature variations by the translucent composite of layers 150, 161.

The method consists generally of successively molding one or two sides of translucent composite, such as cloth and resin, over an aperture 7, buffing, sanding and wet sanding these sides until a proper finish is obtained on the body panel 10. The piece 160 of the body panel 10 within the aperture 7, ultimately discarded, is only removed once it has served as backing support to a first layer of translucent material. To help remove the piece of body panel 160, a layer of mold release compound product 140 as shown in FIG. 7.

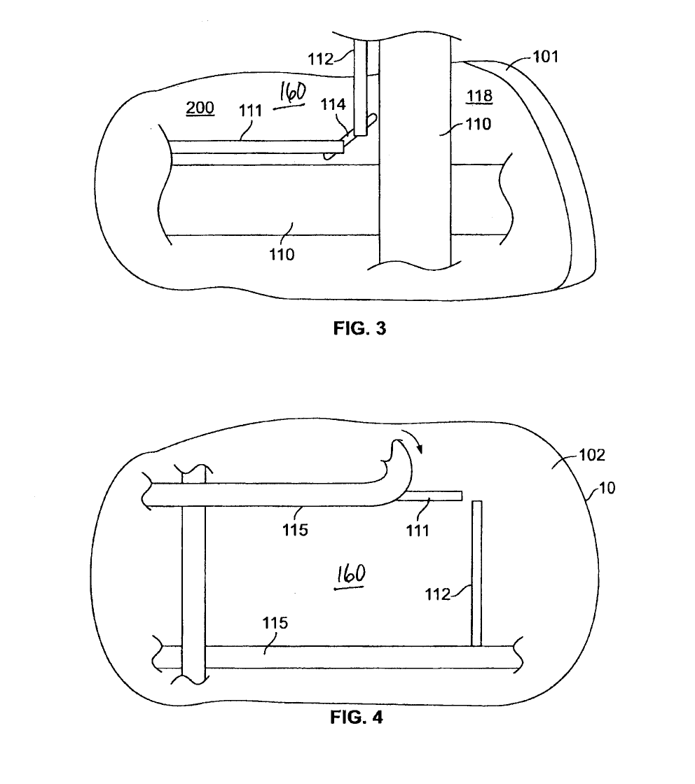

In one embodiment, a nontranslucent body panel portion 118 includes an outer surface 101 and an inner surface 102 and an aperture 7 therein, which are shown in FIG. 2 and defined partially by the slit cuts 111, 112. The translucent body panel portion 200 is made of a first surface 372, and a second surface 371 in opposition and resting in the aperture 7 as shown in FIG. 11. In one preferred embodiment, the aperture 7 is in the shape of a rectangle as shown in FIG. 2 as formed by the slits 111, 112 before the central portion panel 160 is removed. Slits are made vertically 112 and horizontally 11 leaving uncut portions 113 at both the side sections and the corners. In the detailed illustration of FIG. 3, slits 114 are made locally to weaken the metal panel 160 to be removed in a subsequent step. Corners can then be snipped or cut so the panel 160 is removed without damaging a first layer of translucent cloth and resin 150 placed over the panel 160. While one type of weakening of the body panel 160 is shown using slits 114, any other type of weakening is contemplated including using guides, magnets, support frames, or any other types of weakening system.

The placement and use of one or a plurality of apertures 7 each having any known geometry covered by any type of translucent composite material, such as a translucent mesh of carbon or glass fibers embedded in a glass mesh or an epoxy or other suitable resin, for example, thermoset. In a preferred embodiment, two successive layers of fiber glass mesh and epoxy resin are used as both the first layer of translucent cloth and resin 150 and the second layer of translucent cloth and resin 161.

In order to provide the body panel 10 with the appearance that the illuminated selected design 350 as shown in FIGS. 18 and 19 is an integral part of the body panel 10, the first and second layers of translucent composite, such as cloth and resin, 150, 161 are given the appropriate surface geometry to mimic the portion of the nontranslucent body panel portion 118 on which they are installed. If, for example, an aperture 7 is made in the central flat portion of a body part 10, then the first surface 372 may be substantially flush with the outer surface 101, and possibly the second surface 371 may be substantially flush with the inner surface 102. In many cases, only the first surface 372 and the outer surface 101 of the body part 10 is visible and requires a surface finish to mimic the portion of the nontranslucent body panel portion 118. If the aperture 7 is made in a portion of the body part 10 that connects with a connector, what is contemplated is the use of a translucent connector in the shape of the replaced connector (not shown). If, for example, the body part 10 has a scaled outer surface 101, the first surface 372 may also be in a shape that mimics this pattern in appearance either via surface finish or surface geometry.

The term “aligned” as used herein describes how the outer surface 101 and the first surface 372 are interrelated and how the inner surface 102 and the second surface 371 are also interrelated. The term “aligned” in regards to this interrelation may also mean that visually adjacent surfaces that are of such disposition, relation, and position to give the impression to an observer that the surfaces are in unity and should be adjacently placed within the vehicle part or the vehicular accessory. In one embodiment, the outer surface 101 and the first surface 372 are aligned, and the inner surface 102 and the second surface 372 are aligned.

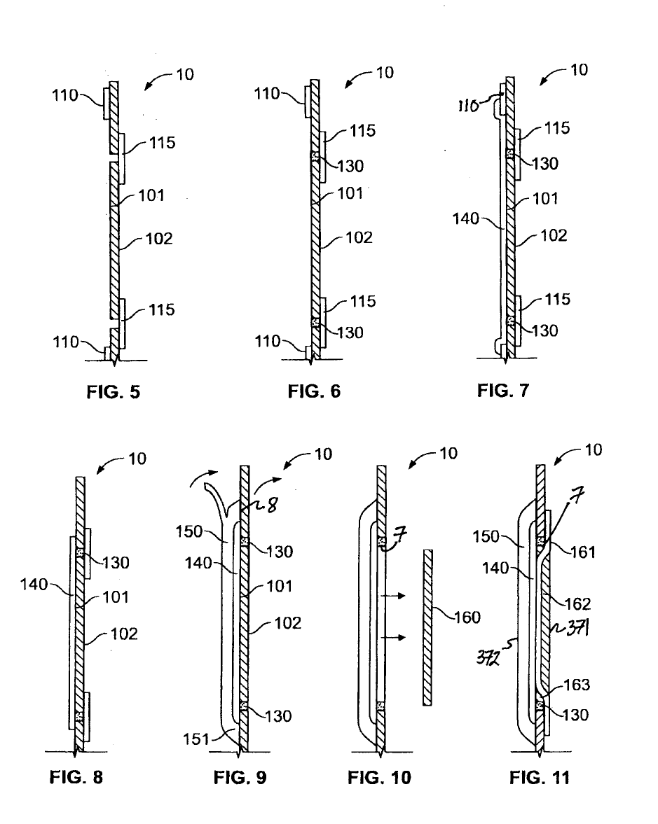

FIG. 2 shows how a first mask made of tape 110 can be placed around the work area. FIG. 5 and subsequent FIGS. 6 and 7 show this tape 110. FIG. 5 also shows in plan view how a second mask 115, also made of tape, for example, can be placed upon the cut slits 111, 112, to offer backing support for a polyester filler 130 of any type to be inserted in the slit cuts 111, 112. This step is illustrated in FIG. 6. While the use of filler 130 is contemplated, if narrower cut slits 111, 112 or a thicker first layer 150 is used, the use of filler 130 may not be required. What is also contemplated is the use of a removable support, rail, or rack to serve as filler 130 when inserted in the cut slits 111, 112.

In one embodiment of the present invention, a layer of mold release compound product 140, such as a spray silicone, is placed on the outer surface 101 to prevent the body panel 160 from sticking to the first layer 150 as shown in FIG. 9. In an intermediate step shown in FIG. 8, the tape 110 is removed along with a portion of the mold release product 140. The second mask 115 is also removed from the inner surface 102. FIG. 11 shows as 162, 163 fillers or translucent resin that can be used as known in the art to create a surface finish on either or both of the first and second surfaces 371, 372 to align with the inner and outer surfaces 101, 102.

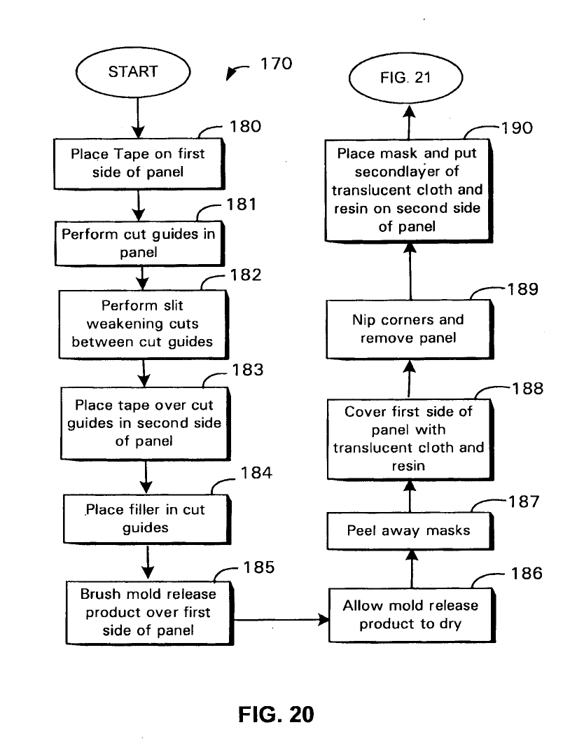

FIGS. 5-11 show the different successive steps needed to create a translucent body panel portion 200 within a nontranslucent body panel portion 118. FIG. 20 shows in a diagrammatic illustration these different steps of the method associated with producing this body panel 10. The method 170 for making an illuminated panel portion 10 for vehicles or vehicular accessories includes performing 182 cut guides 111, 112 in a nontranslucent body panel portion 118 having a first side 101 and a second side 102 along a periphery of an aperture 7 for defining an area for a translucent body panel portion 200 and holding areas 114. This step is shown at FIG. 2. In intermediate steps, tape 110 can be placed on the first side 101 of the body panel 10, and cut guides 181 can be drawn on the first side 101 of the body panel 10.

In a subsequent step, slits 114 are made 182 at the holding areas for weakening the uncut portions at the periphery of the aperture 7, then as shown in FIG. 5, a support is placed 183 on a the second side 102 over the cut guides 111, 112. A filler 130 is then placed 184 in the cut guides as described above. Then, a mold release product as shown in FIG. 7 is sprayed, brushed, or layered 185 over the first side 101 to prevent the panel 160 from sticking to the translucent composite, such as cloth and resin, 150 layered on the panel 160. The mask tape 110 is then removed from the outer surface 101 once the mold release product has been allowed to dry 186. In step 188 shown in FIG. 9, the first side 372 of the panel 160 is covered with translucent cloth and resin. Once corners that have been weakened by a slit 114 are cut, the panel 160 is removed 189.

Finally, in one embodiment, the second side 371 of the panel 200 is covered 190 with a second layer of translucent composite, such as cloth and resin, 161. This embodiment is shown at FIG. 11. To illuminate the panel, a light is disposed in relation to the panel 200 for illuminating through the area for the translucent body panel portion as shown figuratively in FIG. 16.

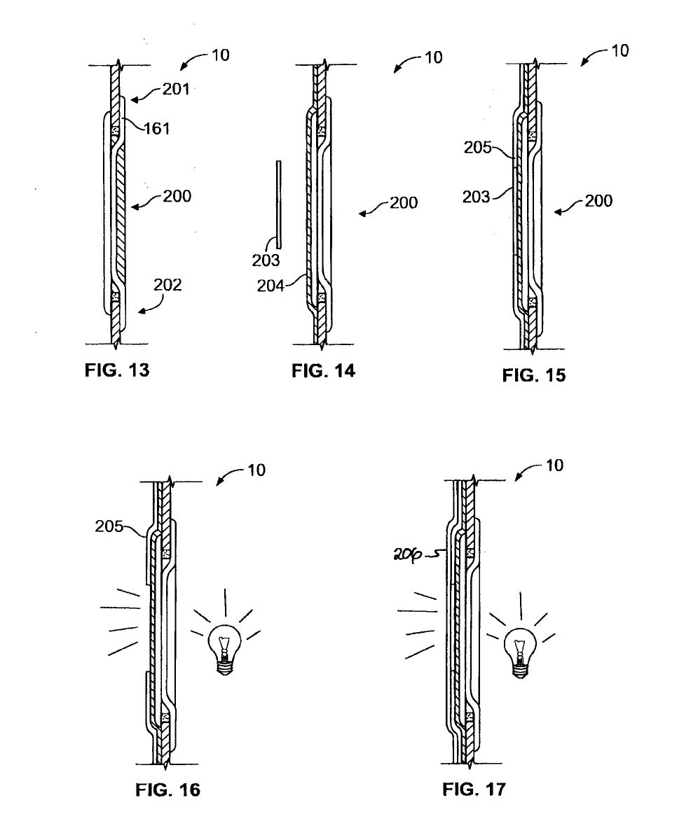

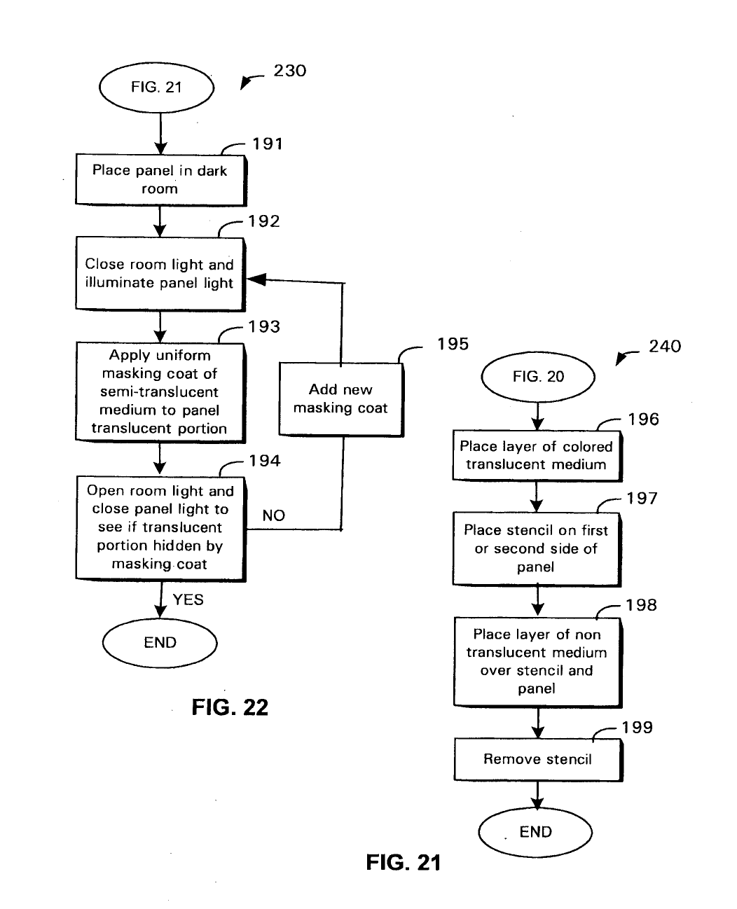

The body panel for illumination 10 further includes a coat of nontranslucent polymer 205 as shown in FIGS. 15 and 16, such as paint, polymer, adhesive vinyl or other suitable material placed over a segment of the translucent body panel portion 200 as shown in FIG. 16 to create in the uncovered segment by the polymer 205 of the translucent body panel portion a selected design shown in FIGS. 18 and 19. For the purpose of simplicity, FIG. 13 shows the body panel 10 of FIG. 11 where the layer of mold release product has been removed. In FIG. 14, and as shown in subsequent functional steps in FIG. 21, a layer 196 of colored, translucent polymer 204 is placed on the surface of the outer surface 101. A stencil 203 is then placed 197 on the first or second side 101, 102 of the panel 10 in the translucent area 200 as shown in FIG. 14. A layer of nontranslucent polymer is then placed over the stencil 203 and panel 198 to create the design element 350. FIG. 15 illustrates this configuration. Finally, the stencil 203 is removed to allow light from inside the panel 10 to shine through the translucent body panel portion 200.

FIG. 22 describes further subsequent steps to the method shown at FIGS. 20 and 21 for creating a “ghosted” or selectively visible effect. An embodiment is shown in FIG. 17 where a layer of semitranslucent polymer, such as paint or vinyl 206, is placed over the stencil layer. This semitranslucent polymer, such as, for example, a black color, may be of sufficient opacity to darken the translucent portion of the design element 350 while allowing the light to shine through the translucent body panel portion 200 once the light is illuminated as shown in FIG. 17.

The “ghosted” effect implies that the design element 350 is hidden from view under normal circumstances by a choice of color in the polymer 206 or by any other means. A panel on a vehicle, a wall or any other accessory appears to have a first appearance, but when a lighting effect is activated in the back of the surface, the design element 350 appears and is then selectively visible. The term ghost or phantom designates here a design element 350 that can be made to disappear from obvious sight when a lighting effect is deactivated.

To achieve this selectively visible effect, the panel may be placed 191 in a dark room and the light is made to illuminate the panel at the translucent body panel portion and display the selected design 350. The room light 192 is then closed to better perceive the illuminated selected design 350. A painter or a worker using the semitranslucent polymer then applies 193 a first uniform masking coat of a semitranslucent polymer 206 over the selected design 350. The room light is then opened 194 to verify if the masking coat 206 masks the selected design 350. If the polymer is not sufficiently opaque, the operation is repeated 195 until a desired level of masking effect is obtained. By using both the room light and the backlight to guide a worker placing on the semitranslucent polymer 206, the worker is able to create a uniform effect over the design element 350.

In one embodiment, the masking coat 206 is of a similar color as a color of the nontranslucent body panel portion to better mask the selected design. The masking coat 206 can also be given a shiny finish to better mask the selected design 350. In other embodiments, LED lights are used as backlights. A vector art plotter or other similar of like device can be used to create a stencil 203 as shown in FIG. 14 to be placed upon at least one of the surfaces 371, 372 of the translucent body panel portion 200. This stencil can be made, for example, of colored or uncolored vinyl covering with adhesive, or any equivalent.

While this disclosure describes the general and principal elements and steps associated with the work conducted on body panels 10, many intermediate and intermediary steps commonly known in the art and used routinely may have not been described specifically. For example, steps such as sanding, touch painting, masking, coat layering, paint preparation, sanding preparation, surface preparation, buffing, cleaning, paint drying, masking, drying, and the like are contemplated when used to achieved useful results.

Persons of ordinary skill in the art appreciate that although the teachings of the disclosure have been illustrated in connection with certain embodiments and methods, there is no intent to limit the invention to such embodiments and methods. On the contrary, the intention of this disclosure is to cover all modifications and embodiments falling fairly within the scope the teachings of the disclosure, including, without limitation, any object that may have a panel portion.

1. A panel for illumination of a selected design, comprising:
a nontranslucent panel portion with an outer surface and an inner surface and an aperture therein, and
a translucent panel portion with a first surface and a second surface in opposition disposed in the aperture such that the outer surface and the first surface are aligned, and the inner surface and the second surface are aligned, wherein the translucent panel portion comprises at least a first layer having translucent composite forming the first surface, and a coat of nontranslucent polymer over a segment of the translucent panel portion to create in the uncovered segment by the polymer of the translucent panel portion a selected design.

2. The panel for illumination of claim 1, wherein the translucent panel portion comprises a second layer of translucent composite forming the second surface.

3. The panel for illumination of claim 1, wherein the translucent panel portion further comprises a layer of colored polymer for coloring the selected design formed in the uncovered segment by the polymer of the translucent panel portion.

4. The panel for illumination of claim 1, wherein the translucent panel portion is rectangular in shape.

5. The panel for illumination of claim 2, wherein the translucent panel further includes a layer of mold release product between the first layer and the second layer.

6. The panel for illumination of claim 5, wherein the translucent panel further includes a filler between the first layer and the second layer.

7. The panel for illumination of claim 1, wherein the translucent panel portion further comprises a layer of semitranslucent polymer.

8. The panel for illumination of claim 3, wherein the translucent panel portion further comprises a layer of semitranslucent polymer to hide the colored polymer unless a light source is disposed in relation to the translucent body panel portion for illuminating said selected design.

9. The panel for illumination of claim 1, wherein the nontranslucent panel portion is made of metal.

10. The panel for illumination of claim 9, wherein the panel portion is taken from an apparatus taken from the group of a cabinet, a machine, a car, a truck, or a motorcycle.

11. The panel for illumination of claim 1, wherein the panel portion is a vehicle accessory.

12. An illuminated panel for displaying a selected design, comprising:
a nontranslucent panel portion with an outer surface and an inner surface and an aperture therein,
a translucent panel portion with a first surface and a second surface in opposition disposed in the aperture such that the outer surface and the first surface are aligned, and the inner surface and the second surface are aligned, wherein the translucent panel portion comprises a first layer having translucent composite forming the first surface, and a coat of nontranslucent polymer over a segment of the translucent panel portion to create in the uncovered segment by the polymer of the translucent panel portion a selected design, and
a light source disposed in relation to the translucent panel portion for illuminating said selected design.

13. The illuminated panel for illumination of claim 12, wherein the translucent body panel portion comprises a second layer of translucent composite forming the second surface.

14. The illuminated panel of claim 12, wherein the translucent body panel portion further comprises a layer of colored polymer for coloring the selected design formed in the uncovered segment by the polymer of the translucent body panel portion.

15. The illuminated panel of claim 14, wherein the light source is a colored light source of the same color as the colored polymer.

16. The illuminated panel of claim 12, wherein the translucent panel portion is rectangular in shape.

17. The illuminated panel of claim 13, wherein the translucent panel further includes a layer of mold release product between the first layer and the second layer.

18. The illuminated panel of claim 12, wherein the translucent panel portion further comprises a layer of semitranslucent polymer to hide the colored polymer unless the light source is disposed in relation to the translucent panel portion for illuminating said selected design.

19. The illuminated panel of claim 12, wherein the nontranslucent panel portion is made of metal.

20. The illuminated panel of claim 12, wherein the panel portion is taken from an apparatus taken from the group of a cabinet, a machine, a car, a truck, or a motorcycle.

21. The illuminated panel of claim 12, wherein the panel portion is a vehicle accessory.

22. A method for making an illuminated panel portion, comprising:
performing cut guides in a nontranslucent panel portion having a first side and a second side along a periphery of an aperture for defining an area for a translucent panel portion;
performing slit weakening cuts at the holding areas for weakening the uncut portions at the periphery of the aperture;
placing a support on the second side over the cut guides;
placing filler in the cut guides and brushing a mold release product over the first side;
covering the first side of panel with translucent composite;
removing a panel section defined by the periphery of the aperture from the second side by snipping the holding areas;
covering the second side of panel with translucent composite; and
disposing a light source in relation to the panel for illuminating through the area for the translucent panel portion.

23. The method of claim 22, further comprising:
placing a stencil of a selected design in the area for the translucent panel portion;
covering the area around the stencil with a layer of polymer;
removing the stencil to allow the surface below the stencil free of the layer of polymer to channel the light from the light source through the translucent panel portion.

24. The method of claim 23, further comprising laying a coat of colored, semitranslucent polymer on the translucent panel portion to color the selected design.

25. The method of claim 24, further comprising:
placing the illuminated panel in a dark room and causing the light source to illuminate the panel at the translucent panel portion and display the selected design;
closing the room illumination to better perceive the illuminated selected design;
applying a uniform masking coat of a semitranslucent polymer over the selected design;
opening the room illumination and close the light source to verify if the masking coat masks the selected design;
repeating the application of the uniform masking coat and verification of the masking coat until a desired level of masking effect is obtained.

26. The method of claim 25, wherein the masking coat is of a similar color as a color of the nontranslucent panel portion to better mask the selected design.

27. The method of claim 24, wherein the masking coat has a shiny finish to better mask the selected design.

28. The method of claim 22, wherein the aperture is a rectangular shape.

29. The method of claim 22, wherein the nontranslucent panel portion is made of metal.

30. The method of claim 22, wherein the covering of the first and second side of the panel by the translucent composite is performed over an area greater than the aperture defined by the cut guides.

31. The method of claim 30, wherein the area is greater by approximately one inch on each side of the aperture.
